(19) United States
(12) Patent Application Publication
(10) Pub. No.: US 2026/0039609 A1
(43) Pub. Date: Feb. 5, 2026

(54) SECURE CREDENTIAL MANAGEMENT WITH CHAT ASSISTANTS

(71) Applicant: Cisco Technology, Inc., San Jose, CA (US)

(72) Inventors: Kourosh Soroushian, San Diego, CA (US); Jason Paul O’Broin, Alameda, CA (US)

(73) Assignee: Cisco Technology, Inc., San Jose, CA (US)

(21) Appl. No.: 18/790,010

(22) Filed: Jul. 31, 2024

(51) Int. Cl. H04L 51/02; G06F 21/31

(52) U.S. Cl. CPC H04L 51/02; G06F 21/31

(57) ABSTRACT

In one implementation, a device receives a request from a chatbot for user credentials needed to perform an application programming interface call. The device prevents the user credentials from being provided to the chatbot in response to the request. The device provides an instruction to the chatbot indicative of the user credentials not being shared because they are locally available. The device makes the application programming interface call based on an output of the chatbot and using the user credentials.

### TECHNICAL FIELD

The present disclosure relates generally to secure credential management with chat assistants.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, chatbot assistants can be written to perform tasks by chaining multiple calls to one or more LLMs. For example, a first step can consist in formulating a plan in natural language, and subsequent steps in executing on this plan by writing code to call application programming interfaces (APIs) or libraries.

One challenge with respect to using a chatbot to make an API call relates to the sharing of credentials to access the API. Indeed, chatbot assistants may be hosted on private servers, while others may be co-hosted on third-party, non-trusted systems. This makes the sharing of credentials for accessing API calls a potential security risk, were a user to share their credentials outside of their trusted network.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1i illustrate an example communication network;

FIG. 2 illustrates an example network device/node;

FIG. 3 illustrates an example of a key for an application programming interface (API);

FIG. 4 illustrates an example architecture for secure credential management with chat assistants;

FIG. 5 illustrates an example logic diagram for a credential interceptor; and

FIG. 6 illustrates an example simplified procedure for performing credential management with a chat assistant.

### DESCRIPTION OF EXAMPLE IMPLEMENTATIONS

### Overview

According to one or more implementations of the disclosure, a device receives a request from a chatbot for user credentials needed to perform an application programming interface call. The device prevents the user credentials from being provided to the chatbot in response to the request. The device provides an instruction to the chatbot indicative of the user credentials not being shared because they are locally available. The device makes the application programming interface call based on an output of the chatbot and using the user credentials.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

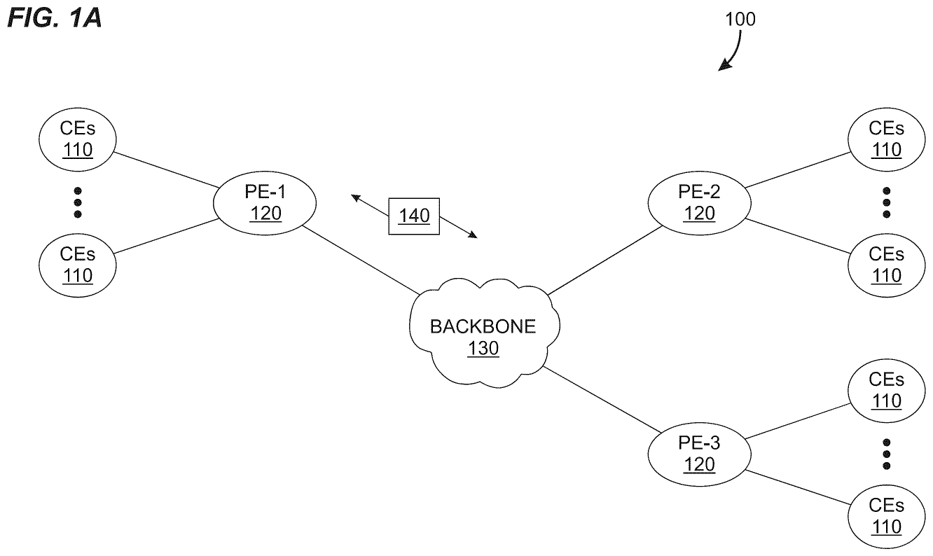

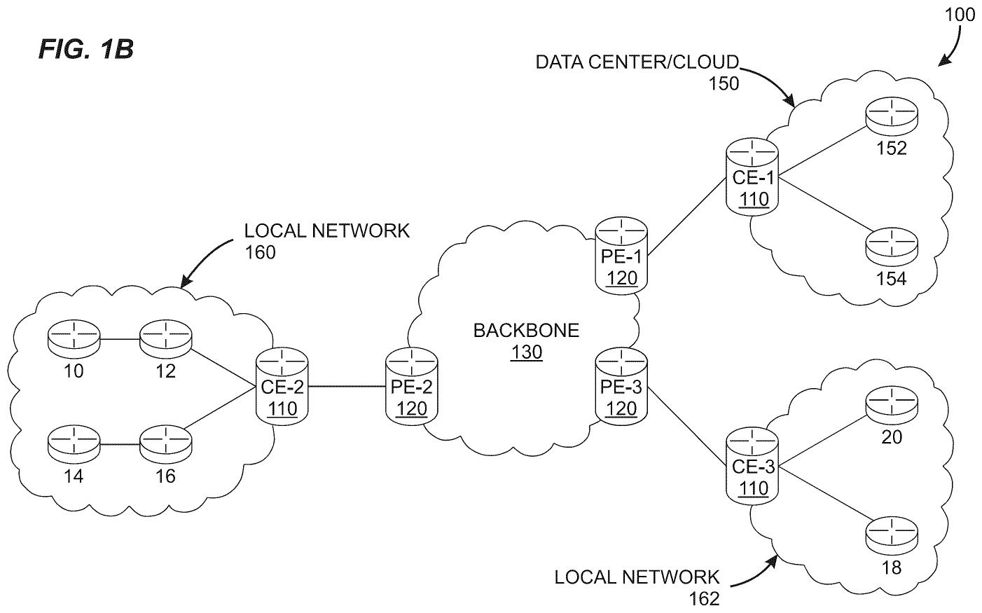

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

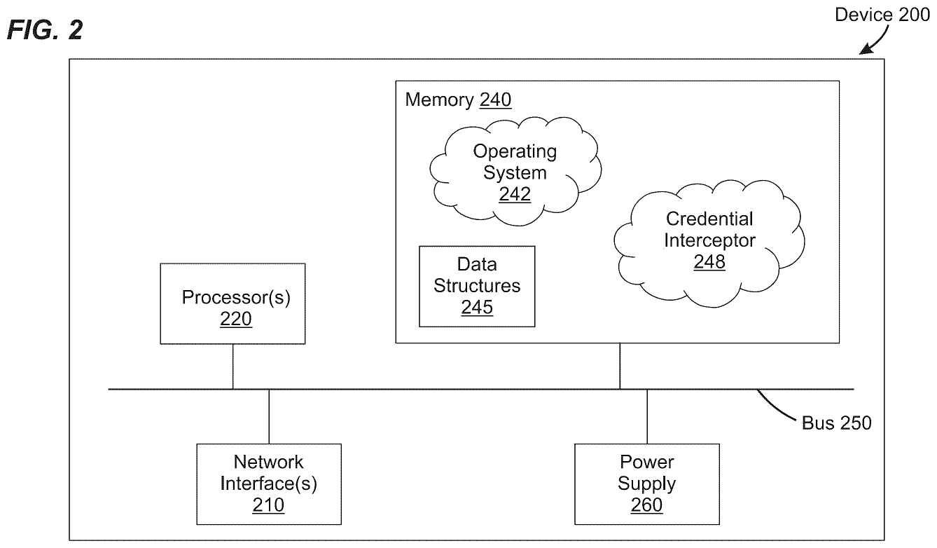

FIG. 2 is a schematic block diagram of an example node/device 200 (e.g., an apparatus) that may be used with one or more implementations described herein, e.g., as any of the computing devices shown in FIGS. 1A-1, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250 and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a process such as credential interceptor 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, credential interceptor 248 may include computer executable instructions that, when executed by processor(s) 220, cause device 200 to perform the techniques described herein. To do so, in some implementations, credential interceptor 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, credential interceptor 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that credential interceptor 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, credential interceptor 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

As noted above, the recent breakthroughs in LLMs, such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, chatbot assistants can be written to perform tasks by chaining multiple calls to one or more LLMs. For example, a first step can consist in formulating a plan in natural language, and subsequent steps in executing on this plan by writing code to call application programming interfaces (APIs) or libraries.

Using artificial intelligence (AI)-based chatbots/chat assistants in support roles can benefit many enterprises. These assistants can be pre-trained with specific topics related to a business role and then can present the information to one or more users in the form of question-and-answer prompts. Chatbot assistants can also be taught to use API function calls to manage any variety of functions for a user, again using natural request-response prompts. While some assistants may be hosted on private servers, other chatbot assistants may be co-hosted on third-party, non-trusted servers, making the sharing of credentials for accessing API calls on a private network a challenge.

More specifically, a chatbot assistant may be trained with specific knowledge related to a product or procedure. This training may be in the form of supplying documentation related to a specific subject matter, internal conversations that have previously occurred by a customer support team, items written specifically for training the AI-based chatbot assistant, or the like. One example of such an assistant is available from Open AI, the creators of Chat-GPT. The assistant can be pre-trained using natural English language prompts, given a set of files for processing, and tailored to specific behaviors using function definitions. The training also enables the assistant to make specialized external API calls which could extend the functionality of the assistant in the configuration and control of a wide variety of publicly or privately available resources. For example, when asking about the weather, the assistant may be instructed to call a REST API which provides a response that can then be interpreted by the chat assistant and provided back to the user.

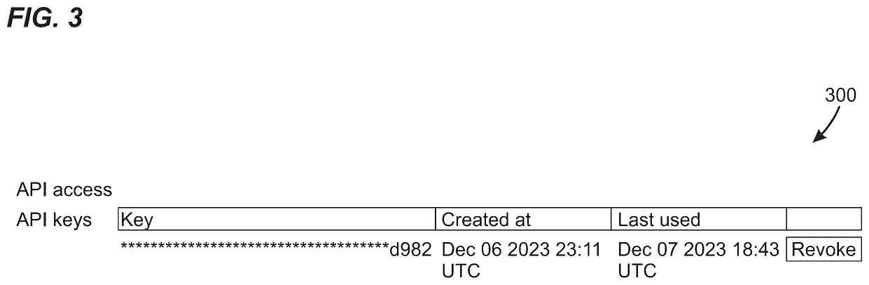

Private REST APIs typically utilize a secret API key or log-in credentials which may be provided to the user for accessing private information and making configuration changes on a private network. FIG. 3 illustrates an example of a key 300 for an API captured from the Cisco Meraki Dashboard application. Such a key may take the form of a cryptographic key that is passed as a user credential when making an API call, to ensure that only authorized users access the API. In other implementations, the user credentials may take the form of a username/password prompt may be used to connect the user with a secret token to access the REST APIs on their platform.

Typically, the chatbot assistant may be informed about the availability of an external function. For instance, below illustrates example code for accessing an API to return a list of available cameras, sensors, or other devices available to the user on a private network:

```
{
  “name”: “get_cameras”,
  “description”: “Use this function to get a list of MV cameras on my network”,
  “parameters”: {
    “type”: “object”,
    “properties”: {
      “cameras”: {
        “type”: “string”,
        “description”: “A list of MV cameras”
      }
    },
    “required”: [
      “camera”
    ]
  }
}
```

The execution of this function may occur on the terminal of the user (e.g., running as Javascript on the browser of the user) or hosted on a computer that has access to a private network. Regardless of where the function is executed, the interactions with the chat AI may need to occur so that the credentials are not shared with the chat assistant.

Secure Credential Management with Chat Assistants

The techniques herein help with securing credentials when utilizing third-party hosted AI chatbots, by intercepting any secret tokens entered in the chat conversation while also improving the user experience by providing information to the chatbot once valid credentials have been entered. This will make for smoother user interactions and speed up interactions with the chatbot by having to avoid checking the validity of API calls with every prompt interaction.

Illustratively, the techniques described herein may be performed by hardware, software, and/or firmware, such as in accordance with credential interceptor 248, which may include computer executable instructions executed by the processor 220 (or independent processor of interfaces 210) to perform functions relating to the techniques described herein.

Specifically, according to various embodiments, a device receives a request from a chatbot for user credentials needed to perform an application programming interface call. The device prevents the user credentials from being provided to the chatbot in response to the request. The device provides an instruction to the chatbot indicative of the user credentials not being shared because they are locally available. The device makes the application programming interface call based on an output of the chatbot and using the user credentials.

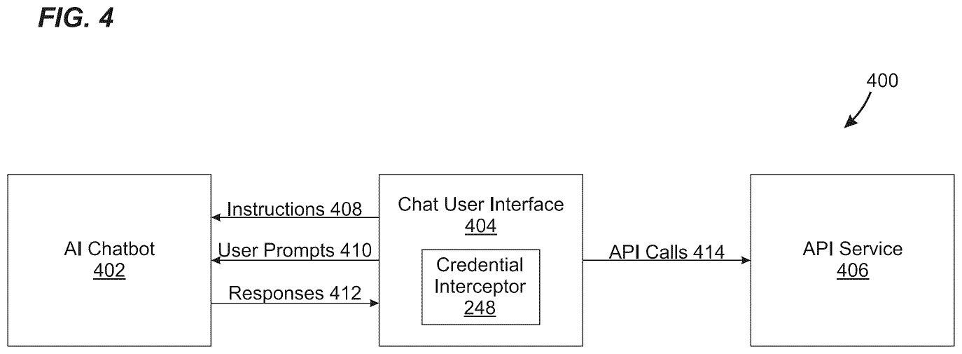

Operationally, FIG. 4 illustrates an example architecture 400 for secure credential management with chat assistants. As shown, architecture 400 may include the following components: an AI chatbot 402, a chat user interface 404, and an API service 406. As would be appreciated, these components may be executed in a distributed manner across any number of computer networks. For instance, chat user interface 404 may be executed by an endpoint device, an intermediate device between a user and AI chatbot 402 (e.g., a device of a service provider), or the like. Similarly, API service 406 may be located in the same network as that of chat user interface 404 or in a remote network therefrom.

Also as shown, the device executing chat user interface 404 (e.g., a device 200) may also execute credential interceptor 248. In some cases, credential interceptor 248 may be implemented as part of chat user interface 404. In other cases, credential interceptor 248 may be implemented separately from chat user interface 404 and operate in conjunction therewith. In yet additional implementations, credential interceptor 248 may be executed by a separate device entirely from that of chat user interface 404 and operate in conjunction therewith, in which case the combination of executing devices may be viewed as a singular device for purposes of the teachings herein.

As would be appreciated, AI chatbot 402 may leverage one or more language models, to allow a user of chat user interface 404 to interact with it via text. For instance, AI chatbot 402 may include one or more LLMs or other language models, to generate text in response to a prompt sent by chat user interface 404.

In various implementations, the techniques herein add a specific step that instructs AI chatbot 402 to distinguish between prompts that require access to the service provider's network and those requests that are purely informational and can be handled by the third-party provider. Any request that requires access to the network of the user will be preempted with a check that will determine if the user has already entered their credentials via chat user interface 404 or not, and request the user enter their credentials if they are not available.

In addition, credential interceptor 248 may also detect whether credentials have been entered by the user without AI chatbot 402 requesting them, in which chat user interface 404 may inform AI chatbot 402 that valid credentials are available to avoid having chat user interface 404 asking for them in the future. Note that credentials may be in the form of username/password entered in a separate screen, or a secret token or key which is entered in the context of the chat session itself.

More specifically, consider the case in which a user of chat user interface 404 issues user prompts 410 to AI chatbot 402, causing AI chatbot 402 to generate responses 412. In some instances, responses 412 may include a request for the user of chat user interface 404 to supply user credentials for purposes of making one or more API calls 414 to API service 406.

In case of any of responses 412 from AI chatbot 402 including a request for credentials, credential interceptor 248 may parse any resulting user prompts 410 that include such information. For instance, AI chatbot 402 may ask the user for an API key. In turn, if credential interceptor 248 discovers the inclusion of such a key in any of user prompts 410, it may validate the API key, provide direct feedback to the user about its validity, and/or prevent chat user interface 404 from providing the API key to AI chatbot 402.

Instead of providing the supplied user credentials to AI chatbot 402, credential interceptor 248 may instead cause chat user interface 404 to provide instructions 408 to AI chatbot 402 indicating that valid credentials are available, such that it does not need to ask the user for them in the future (e.g., during the same chat session, during a certain amount of time, etc.). Likewise, if credential interceptor 248 determines that the user credentials have expired, it may provide instructions 408 to AI chatbot 402 asking it to restart asking for credentials again for transactions related to the private network of the client.

Once AI chatbot 402 has received instructions 408, it may provide one or more further responses 412 back to chat user interface 404 that include an output that allows the device of chat user interface 404 to make one or more API calls 414 to API service 406. For instance, responses 412 may include a function or other code for execution to access API service 406. In some cases, credential interceptor 248 may be responsible for ensuring that valid credentials are used as part of the one or more API calls 414.

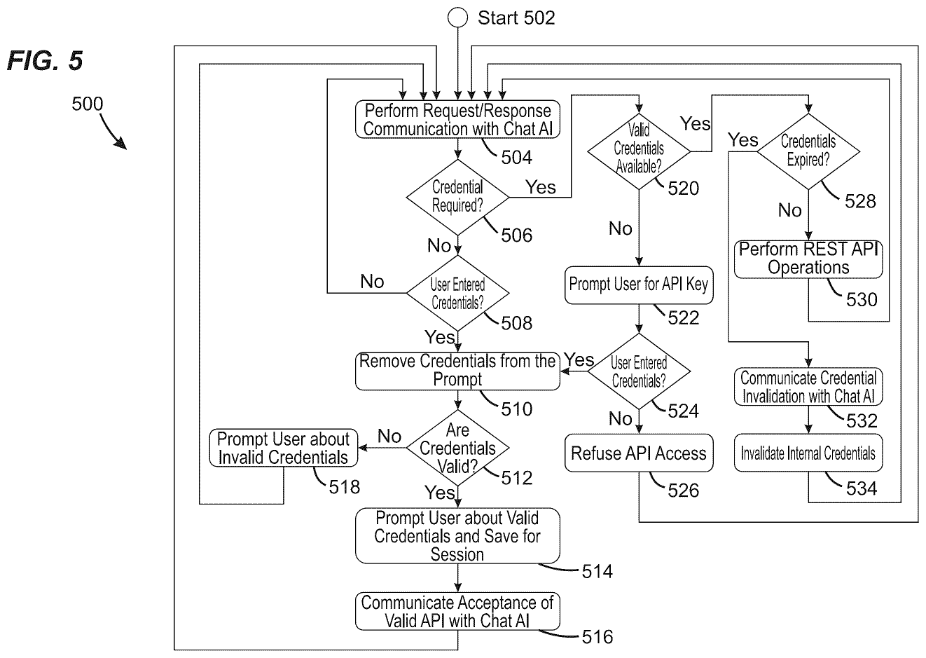

FIG. 5 illustrates an example logic diagram 500 for a credential interceptor, such as credential interceptor 248, in various implementations. As would be appreciated, the same functionality described above may also apply for any user credentials entered in a separate flow (e.g., in a pop-up box in a web browser) whereby credential interceptor 248 removes any username/password combination, key, or other credential from a prompt sent to the chatbot, thereby preventing the credentials from being shared.

As shown, credential interceptor 248 may start at step 502 by allowing chat user interface 404 to perform request/response communications with AI chatbot 402 (step 504). In turn, credential interceptor 248 may assess the textual exchanges between the two, to detect whether user credentials are being requested (step 506). If not, then credential interceptor 248 may continue to assess whether the user of chat user interface 404 has entered any such credentials (step 508). If not, processing may simply return back to step 504. Otherwise, credential interceptor 248 may prevent the credentials from being sent to AI chatbot 402 by removing the credentials from a prompt (step 510).

Optionally, credential interceptor 248 may also assess whether any provided credentials are valid (step 512). If not, credential interceptor 248 may notify the user about the invalid credentials and potentially request valid credentials, as well (step 518). Otherwise, credential interceptor 248 may notify the user that their credentials are valid and save them for further use (step 514). Credential interceptor 248 may then communicate acceptance of a valid API with AI chatbot 402 (step 516) and return to step 504.

In cases in which AI chatbot 402 asks for credentials at step 506, credential interceptor 248 may likewise determine whether the available credentials are valid (step 520). If not, credential interceptor 248 may prompt the user for such credentials (step 522) and then determine whether the user entered such credentials (step 524). If they did, processing may continue on to step 510, as detailed above. However, if the user fails to enter credentials, credential interceptor 248 may refuse access to the API (step 526) and return processing to step 504.

If credential interceptor 248 determines that valid credentials are available at step 520, it may then determine whether the credentials are expired (step 528). If not, it may perform the API call (step 530) and return processing to step 504. If the credentials are expired, though, credential interceptor 248 may instead notify AI chatbot 402 that the credentials are invalid (step 532) and invalidate them locally as well (step 534), before returning processing back to step 504.

The following sample code demonstrates one example as to how credential interceptor 248 may remove an API key or other credential from a chat prompt:

```
      api_key = find_api_key(prompt)
    if(api_key is not None):
        if(validate_api_key(api_keys[0]) is False:
        print(“Your API key is invalid! Please provide a valid API Key.”)
  continue
save_api_key(api_key)
          send_message_to_chat_ai(chat_ai_id, ″This is the chat administrator. An API
key has been submitted by the user and intercepted by the prompt
analyzer. Please remind the user that their API key has been
received, but not shared with you.″)
```

A sample Python program for finding an API key in the chat conversation is also shown below, which checks for the occurrence of one digit and one lower-case character in a contiguous string of at least 30 characters:

```
  def find_api_key(text):
    # Split the text into words
    words = text.split( )
    # Check each word and return the first occurrence of an API key
    for word in words:
      # Check if the word is at least 30 characters long
      if len(word) >= 30:
        # Check if the word contains only lowercase letters and at least one
number
        if word.islower( ) and any(char.isdigit( ) for char in word):
          return word
    return None
```

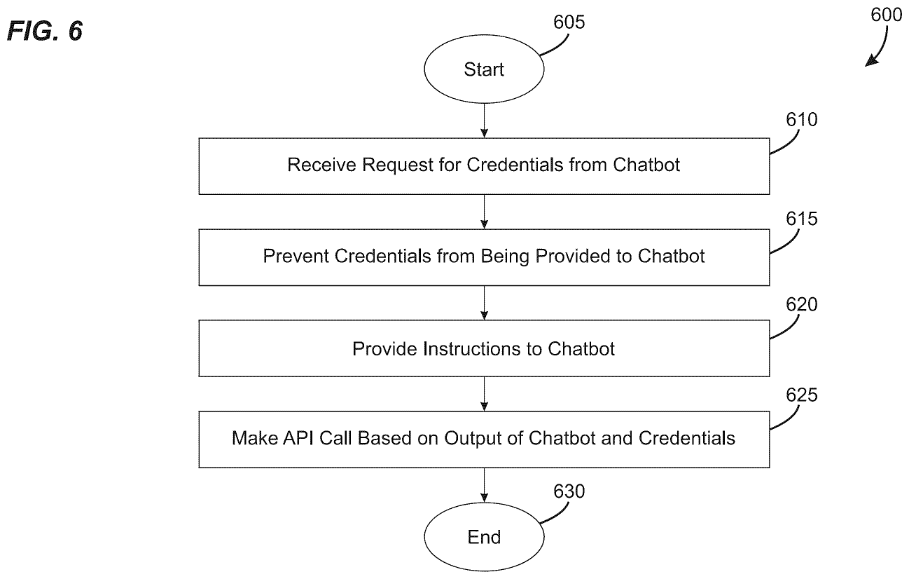

FIG. 6 illustrates an example simplified procedure 600 (e.g., a method) for performing credential management with a chat assistant, in accordance with one or more implementations described herein. For example, a non-generic, specifically configured device (e.g., device 200), such as a router, firewall, controller for a network, endpoint, server, or the like, may perform procedure 600 by executing stored instructions (e.g., credential interceptor 248). The procedure 600 may start at step 605, and continues to step 610, where, as described in greater detail above, the device may receive a request from a chatbot for user credentials needed to perform an application programming interface call. In some implementations, the chatbot comprises a large language model (LLM).

At step 615, as detailed above, the device may prevent the user credentials from being provided to the chatbot in response to the request. In one implementation, the device may do so by stripping the user credentials from a textual response issued by a user in response to the request. In some implementations, the device may prompt a user for the user credentials, after receiving the request, when the user credentials are expired or not locally available. In one instance, the device is an endpoint device operated by a user associated with the user credentials.

At step 620, the device may provide an instruction to the chatbot indicative of the user credentials not being shared because they are locally available, as described in greater detail above. In various implementations, the user credentials comprise a cryptographic key.

At step 625, as detailed above, the device may make the application programming interface call based on an output of the chatbot and using the user credentials. In one implementation, the device may also store the user credentials for use to make a further application programming interface call. In some implementations, the device may further validate the user credentials, prior to making the application programming interface call. In various implementations, the output of the chatbot comprises code to make the application programming interface call. In one implementation, the device is an intermediate device between the chatbot and a server to which the application programming interface call is made.

Procedure 600 then ends at step 630.

While there have been shown and described illustrative implementations that provide for performing credential management with chat assistants, it is to be understood that various other adaptations and modifications may be made within the spirit and scope of the implementations herein. For example, while certain implementations are described herein with respect to using certain models for purposes of making API calls, the techniques herein are not limited as such and can be used for purposes of managing the credentials associated with any task performed via a chatbot, such as executing a command line interface (CLI) command, logging into a remote system, or the like. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
receiving, at a device, a request from a chatbot for user credentials needed to perform an application programming interface call;
preventing, by the device, the user credentials from being provided to the chatbot in response to the request;
providing, by the device, an instruction to the chatbot indicative of the user credentials not being shared because they are locally available; and
making, by the device, the application programming interface call based on an output of the chatbot and using the user credentials.

2. The method as in claim 1, wherein the output of the chatbot comprises code to make the application programming interface call.

3. The method as in claim 1, wherein the chatbot comprises a large language model (LLM).

4. The method as in claim 1, wherein the user credentials comprise a cryptographic key.

5. The method as in claim 1, further comprising:
prompting a user for the user credentials, after receiving the request, when the user credentials are expired or not locally available.

6. The method as in claim 1, further comprising:
validating, by the device, the user credentials, prior to making the application programming interface call.

7. The method as in claim 1, further comprising:
storing the user credentials for use to make a further application programming interface call.

8. The method as in claim 1, wherein the device is an endpoint device operated by a user associated with the user credentials.

9. The method as in claim 1, wherein the device prevents the user credentials from being provided to the chatbot in response to the request by:
stripping the user credentials from a textual response issued by a user in response to the request.

10. The method as in claim 1, wherein the device is an intermediate device between the chatbot and a server to which the application programming interface call is made.

11. An apparatus, comprising:
one or more network interfaces;
a processor coupled to the one or more network interfaces and configured to execute one or more processes; and
a memory configured to store a process that is executable by the processor, the process when executed configured to:
receive a request from a chatbot for user credentials needed to perform an application programming interface call;
prevent the user credentials from being provided to the chatbot in response to the request;
provide an instruction to the chatbot indicative of the user credentials not being shared because they are locally available; and
make the application programming interface call based on an output of the chatbot and using the user credentials.

12. The apparatus as in claim 11, wherein the output of the chatbot comprises code to make the application programming interface call.

13. The apparatus as in claim 11, wherein the chatbot comprises a large language model (LLM).

14. The apparatus as in claim 11, wherein the user credentials comprise a cryptographic key.

15. The apparatus as in claim 11, wherein the process when executed is further configured to:
prompt a user for the user credentials, after receiving the request, when the user credentials are expired or not locally available.

16. The apparatus as in claim 11, wherein the process when executed is further configured to:
validate the user credentials, prior to making the application programming interface call.

17. The apparatus as in claim 11, wherein the process when executed is further configured to:
store the user credentials for use to make a further application programming interface call.

18. The apparatus as in claim 11, wherein the apparatus is an endpoint device operated by a user associated with the user credentials.

19. The apparatus as in claim 11, wherein the apparatus prevents the user credentials from being provided to the chatbot in response to the request by:
stripping the user credentials from a textual response issued by a user in response to the request.

20. A tangible, non-transitory, computer-readable medium storing program instructions that cause a device to execute a process comprising:
receiving, at the device, a request from a chatbot for user credentials needed to perform an application programming interface call;
preventing, by the device, the user credentials from being provided to the chatbot in response to the request;
providing, by the device, an instruction to the chatbot indicative of the user credentials not being shared because they are locally available; and
making, by the device, the application programming interface call based on an output of the chatbot and using the user credentials.
